(19) United States
(12) Patent Application Publication
(10) Pub. No.: US 2024/0221045 A1
(43) Pub. Date: Jul. 4, 2024

(54) Machine Learning Method for Correlating Disparate Data Sets

(71) Applicant: SPINS LLC, Chicago, IL (US)

(72) Inventors: Brian Michael Ritz, Granger, IN (US); Zachary Nathan Rosenberg, Chicago, IL (US); James Ernest Fonseca, Chicago, IL (US)

(73) Assignee: SPINS LLC, Chicago, IL (US)

(21) Appl. No.: 18/092,064

(22) Filed: Dec. 30, 2022

(51) Int. Cl. G06Q 30/0601; G06N 20/00

(52) U.S. Cl. CPC G06Q 30/0623; G06N 20/00

(57) ABSTRACT

A machine learning model is trained to recognize disparate product data in a variety of different data formats. The disparate product data is automatically linked with an aggregator's database to allow users to recognize and analyze sales channel information about the products.

### FIELD OF THE DISCLOSURE

The present disclosure relates generally to machine learning methods for correlating disparate sets of data, and more particularly but not exclusively to predicting most likely category information for aggregator product categories of aggregator product information, in the hierarchy of a given retailer, and more particularly for making such predictions where there is an absence of retailer information corresponding to said aggregator product information.

### BACKGROUND

In the retail sales business, it is useful for a retailer to understand how each of the products sold by that retailer are performing. This includes information such as sales volume, time spent on the shelf, sales price, product distribution, and product sales velocity. It is particularly useful for retailers to understand and compare their own internal product information with corresponding information gleaned from other retailers selling the same products. When a retailer develops a stronger understanding of their product performance and comparisons with information from other retailers, this allows the retailer to develop a greater understanding of product sales trends, pricing decisions, benchmarks against which to compare their sales, product assortment decisions, and product promotion decisions. To support retailers in developing these product performance understandings, an information aggregator can collect sales information from a variety of different retailers and aggregate this information in a database. The aggregator advantageously can present this aggregate information to each retailer for the retailer to use in better understanding its own performance information in comparison with other retailers in the same channel.

There is a problem, however, with making this comparison. Each retailer maintains their own data in their own hierarchy. For example, one retailer such as a large grocery chain may categories its products with an extensive hierarchy such as Department (e.g. produce, pharmacy, dry goods, etc.), and then Category (e.g. bread, milk, juices, waters, peanut butter, etc.), Sub-Category (e.g. whole milk, skim milk), Brand, Unit Size, etc. Another retailer may use a more simple hierarchy that simply categorizes products by Department and Category. Additionally, different retailers may use different values for each level of their hierarchy. For example, one retailer may use “produce” as a category for produce, whereas another retailer may use “fresh” as a category for produce. Additionally, even where different retailers may use the same basic hierarchy (e.g. Departments comprising produce, pharmacy, dry goods, and Category comprising bread, milk, juices, waters), different retailers may categorize the same product or product type in different categories. For example, one retailer may categorize coconut water products in the category of “Water”, whereas another retailer may categorize the same products in the category of “Juices”. The aggregator as well may have its own hierarchy that it uses to consolidate all of the disparate retailer information it aggregates from the group of retailers it serves. For example, the aggregator desirably converts all of the incoming retailer information into the aggregator's own data hierarchy before the data is aggregated. This may, for example, cause coconut water products to be aggregated in the category of “Shelf Stable Juices.” This allows the aggregator to maintain a more streamlined database of aggregated product information. This also allows the aggregator to strip out any individual retailer's own hierarchy information from the aggregated data. Stripping out retailer hierarchy information from the aggregated retailer data is useful because it allows each individual retailer to preserve their own hierarchy information as proprietary, and not shared with other potentially competing retailers. But, once the retailer data is aggregated by the aggregator, it becomes difficult for retailers to compare the aggregated data with their own internal data because the two databases use different hierarchies.

Because of this hierarchy mismatch, accurate comparisons of a retailer's own sales with the aggregated sales information are difficult if not impossible. For example, a retailer categorizes coconut water products as “Water” and the aggregator categorizes these same products as “Shelf Stable Juices.” The retailer wishes to understand how its “water” products are selling relative to other retailers in the same channel. If the retailer compares its own “water” category with the aggregator's “water” category, sales of the retailer's coconut water products will be inflated relative to the channel data, because the channel data puts coconut water in a different category. In some circumstances, there will be no category in the aggregator's data that matches up with the retailer's “water” category, so no comparison can even be made. Thus, there is a need for a method of easily and automatically analyzing a retailer's product information and hierarchy and an aggregator's aggregated product information and hierarchy, to learn how the retailer places products into its hierarchy and thereby predict which retailer categories each product represented in the aggregator's database will likely belong to.

### Summary of Preferred Embodiments

In an embodiment, the retailer data is merged with the aggregator data via a product code assigned to each product, for example a UPC code. The UPC code is analyzed to account for the possible presence of a check digit and for potential differences in UPC data formats between the two data sets. A machine learning model is built, using the merged data and the aggregator's data hierarchy. The model analyzes the merged data to identify the strongest match between a given combination of attributes (e.g. brand, unit size, category, sub-category) in the aggregator's hierarchy, and a given entry in the retailer's hierarchy (e.g. a subcategory, or category). This match is used to predict which retailer entry (e.g. a sub-category) each attribute combination in the aggregator's database is likely to map to.

### DRAWINGS

FIG. 1 depicts a retailer data table according to an embodiment of the invention.

FIG. 2 depicts an aggregator data table according to an embodiment of the invention.

FIG. 3 depicts a method for merging a retailer data table and an aggregator data table according to an embodiment of the invention.

FIGS. 4a-c depict a method of converting UPC code formats according to an embodiment of the invention.

FIG. 5 depicts a method of predicting retailer attributes according to an embodiment of the invention.

FIG. 6a depicts a merged product table with one populated row according to an embodiment of the invention.

FIG. 6b depicts the merged product with all populated rows according to an embodiment of the invention.

FIG. 7a depicts a mapping table according to an embodiment of the invention.

FIG. 7b depicts an attribute table according to an embodiment of the invention.

### DETAILED DESCRIPTION

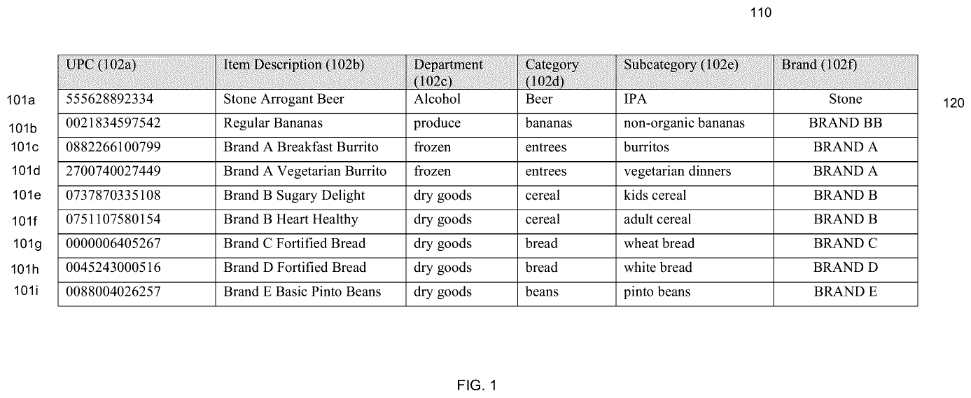

With reference to FIG. 1, an example of a retailer product list 100 is depicted. The product list is represented as a table with columns 110 and rows 120. Each row 120 represents a single product 101a-i that is sold by the retailer. Each column 110 represents an attribute 102 a-f assigned to each of the products 101. The retailer product list 100 implements a retailer product hierarchy 110, represented by the headers for each of the columns 110. In the example shown in FIG. 1, the retailer product hierarchy is made up of the following attributes:
Department (102c)
Category (102d)
Sub-Category (102e)
Brand (102f)

In this example hierarchy, the retailer's products are categorized with a multi-level hierarchy recited in the combination of the Department, Category, Sub-Category and Brand attributes 110c-f. Each product 101a-i is further described with a UPC code 110a and an Item Description 110b. Thus, the product 101a is an IPA Beer in the Alcohol department, from the Stone brand with a Description of Stone Arrogant Beer and a UPC code of 00AA555628892334. The product 101b is a non-organic banana in the Produce department, from Brand BB with a Description of Regular Bananas and a UPC code of 0000000-00002. The particular choices of designations in the multi-level hierarchy may vary from retailer to retailer, based on factors such as the retailer's preferences, the particular channel that the retailer operates in or other factors. Instead of a UPC code, the retailer could use another designator for products, such as an ISBN (typically used for books and other printed materials), a European Article Number (EAN) code or a Japan Article Number (JAN) code.

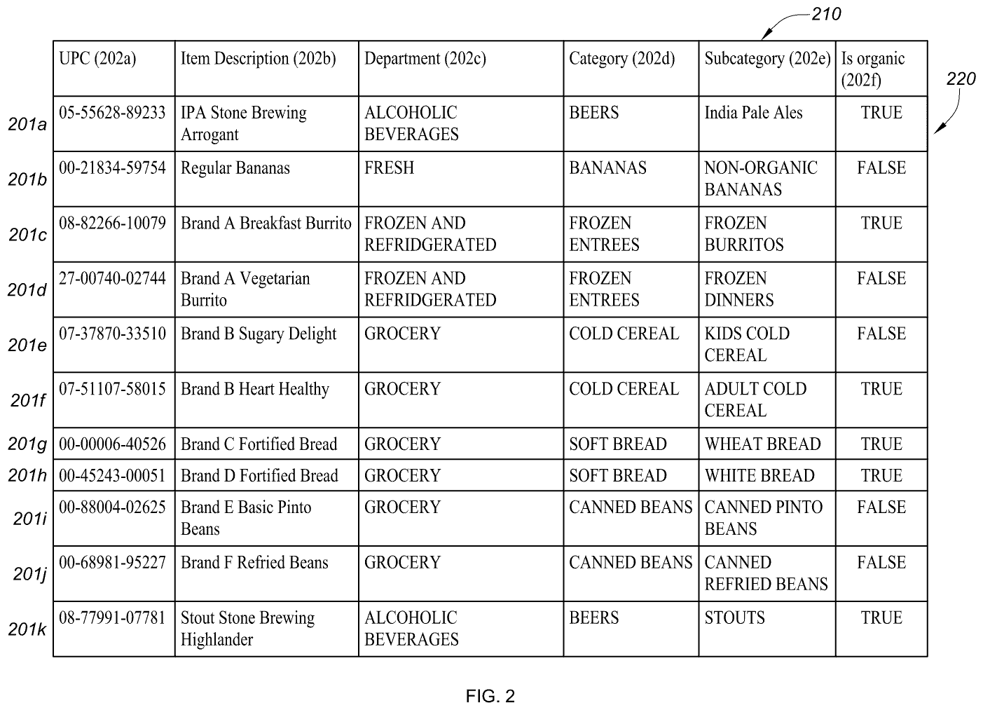

With reference to FIG. 2, an example of an aggregator's product list 200 is depicted. This product list is represented as a table with columns 210 and rows 220. Each row 220 represents a single product 201a-k that is tracked by the aggregator. Each column 210 represents an attribute 202a-f assigned to each of the products 201. The aggregator's product list 200 implements an aggregator hierarchy 210, represented by the headers for each of the columns 210. In the example shown in FIG. 2, the aggregator product hierarchy is made up of the following attributes:
Department (202c)
Category (202d)
Subcategory (202e)
Is Organic (202f)

In this example hierarchy, the aggregator's products are categorized with a different multi-level designation recited in the combination of the Department, Category, Sub-Category and Is Organic attributes. Each product 201a-i is further described with a UPC code 202a and an Item Description 202b. In this table, the product 201a is an India Pale Ale Beer in the Alcoholic Beverages Department with the name IPA Stone Brewing Arrogant, and a UPC code of 05-55628-89233.

The aggregator's hierarchy is different from the example retailer hierarchy of FIG. 1. The retailer includes a Brand column in its hierarchy, which the aggregator does not track. The aggregator includes an Is Organic column in its hierarchy, which the retailer does not track. Additionally, the aggregator and the retailer use different values for the Department, Category, and Sub-Category fields. The aggregator uses Department values of: Alcoholic Beverages, Fresh, Frozen and Refrigerated, and Grocery. The retailer uses Department values of: Alcohol, Produce, Frozen, and Dry Goods. The aggregator uses Category values of: Beers, Bananas, Frozen Entrees, Cold Cereal, Soft Bread and Canned Beans. The retailer uses Category values of Beer, Bananas, Entrees, Cereal, Bread and Beans. The aggregator and retailer each use different sub-category values as well, as seen in FIGS. 1 and 2.

As with the retailer hierarchy, the particular choices of designations in the multi-level hierarchy may vary from aggregator to aggregator, based on factors such as the aggregator's preferences, the particular channels that the aggregator tracks or other factors. Instead of a UPC code, the aggregator could use another designator for products, such as an ISBN (typically used for books and other printed materials), a European Article Number (EAN) code or a Japan Article Number (JAN) code. In an embodiment, the aggregator and the retailer each use at least one product designator in common. The aggregator may use multiple different product codes to designate each product 201 it tracks, for example using a UPC, an EAN and a JAN code to track each product 201 in the aggregator product list 200. This allows the aggregator to aggregate products of retailers that may not even use the same product code as each other.

As can be observed, in this example the information about the same product, stored in the two different database tables 100, 200, is largely dissimilar. Both tables 100, 200 contain an entry for the same product, the Stone Arrogant beer with a UPC code that contains the same data in each table, but that is formatted differently. Row 101a contains the retailer's representation of this product, and row 201a contains the aggregator's representation of the same product. Significantly, the retailer's hierarchy is different than the aggregator's hierarchy, including both different attributes as well as different data for these attributes. Methods of embodiments of the invention allow the retailer data and the aggregator data to be combined, and allow the retailer to understand information contained in the aggregator's databases, without the retailer needing to understand the aggregator's hierarchy.

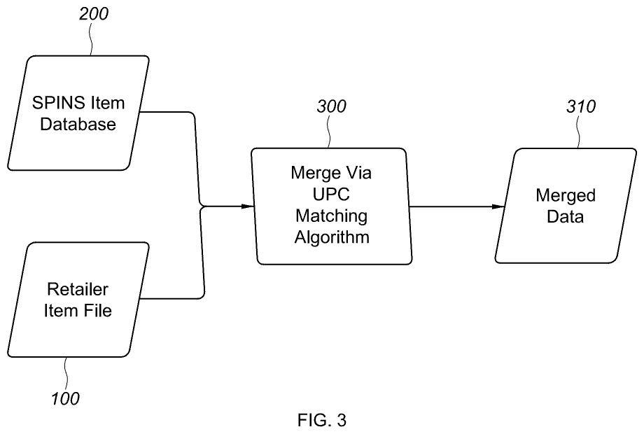

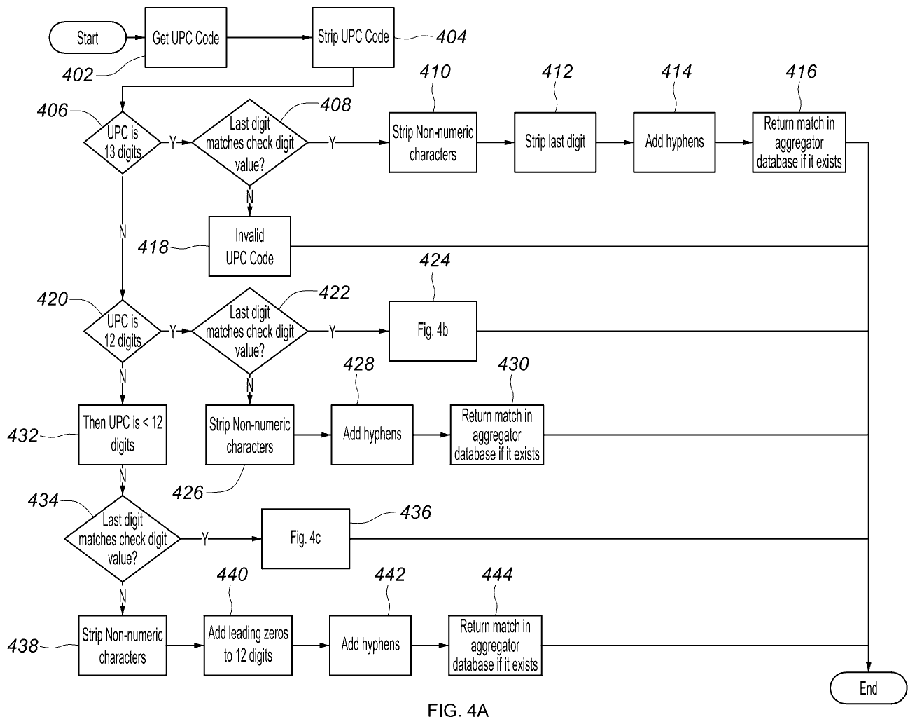

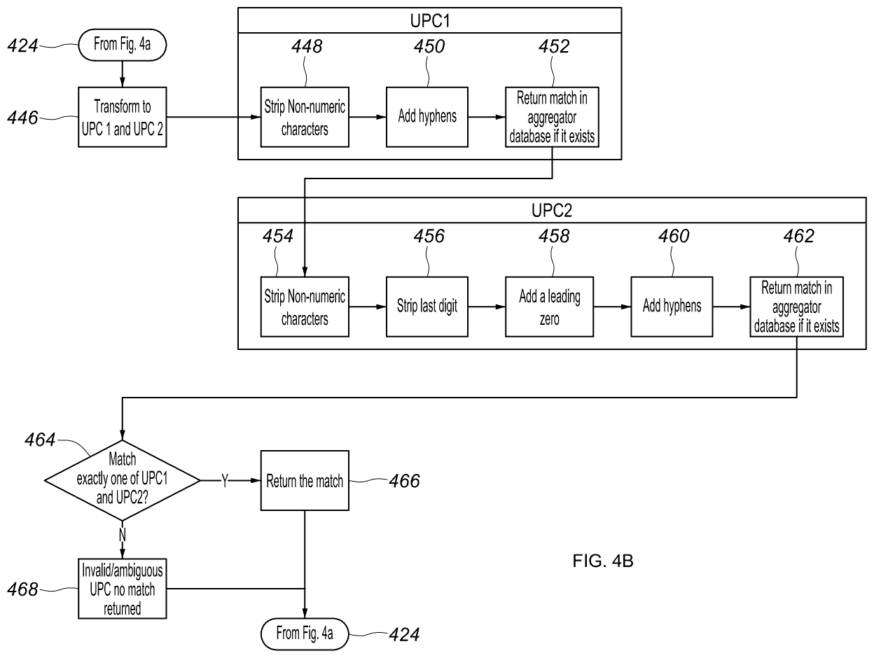

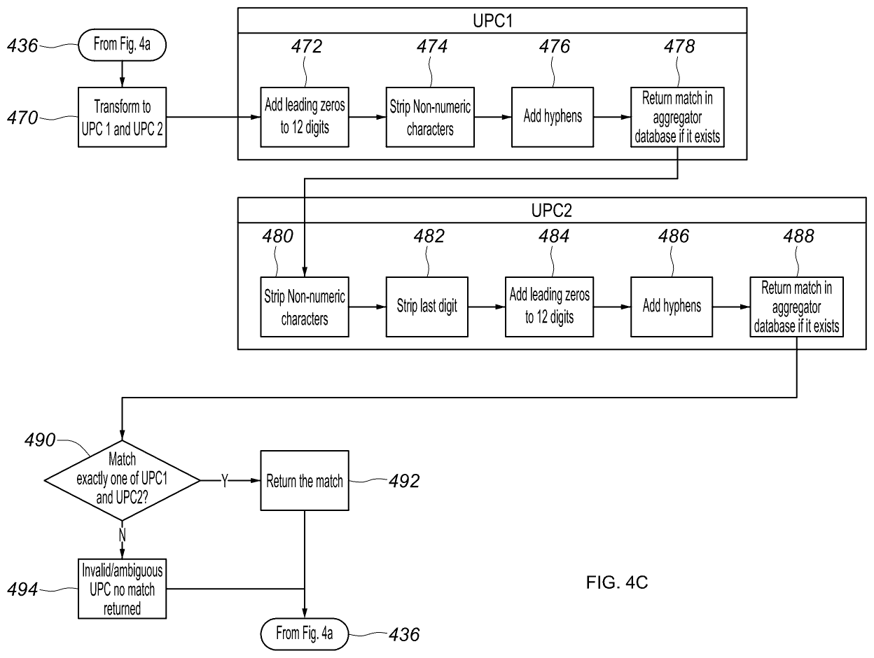

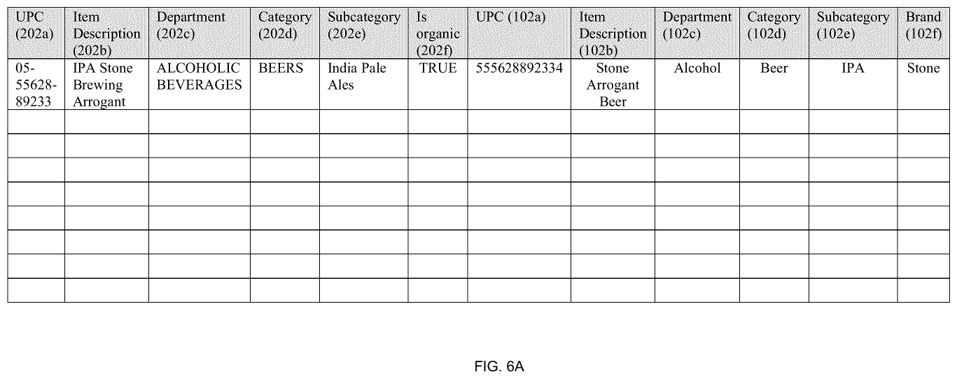

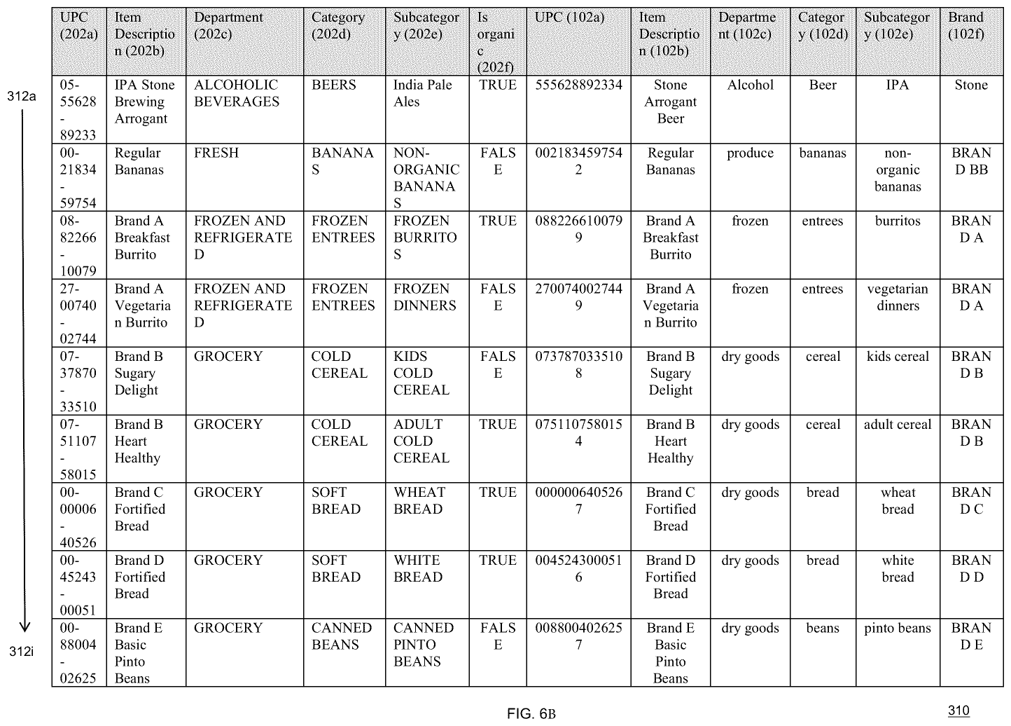

In a method of an embodiment of the invention, shown in FIG. 3, the tables 100 and 200 are merged using a matching algorithm 300 to create a merged data table 310 (See FIGS. 6a-6b). The matching algorithm 300 steps through each entry in the retailer product table 100 and uses the method of FIG. 4a-c to identify a matching entry in the aggregator product table 200. Alternatively, the matching algorithm could step through each entry in the aggregator product table 200, and use the method of FIG. 4a-c to identify a matching entry in the retailer product table 100.

The matched entries are stored in the merged data table 310. FIG. 6a shows a merged data table 310 after one matching entry in FIGS. 1 and 2 has been added. FIG. 6b shows the merged data table 310 after all matching rows in FIGS. 1 and 2 have been added. In an embodiment, this merged data table 310 contains all of the data from the aggregator product list 200, as well as all of the data from the retailer product list 100 that matches an entry in the aggregator product list 200. Alternatively, a subset of the data fields in each row of the aggregator product list 200 and/or retailer product list 100 can be used. Optionally, the merged data table 310 can also contain entries for products listed in the retailer product list 100 but not listed in the aggregator product list 200. In the embodiment of FIG. 3, the tables 100 and 200 are merged using a keyfield, here the UPC code field 110a and 210a. The UPC code is a desirable field to use as the key field, because most consumer products sold worldwide are associated with a unique UPC code. As noted above, alternative fields such as an EAN or JAN code field could also be used. This allows two tables of product information to be merged, even if most of the data in these two tables is not the same in both tables. In alternate embodiments, another field or combination of fields could be used as the key field, as long as that field or combination of fields served to uniquely identify a specific product entry in the table (i.e. no two products in the same table have the same value or combination of values for the key).

Where the UPC code is used as the key field for merging the tables 100 and 200, there is an issue in that UPC code information is commonly represented in a number of different formats. Thus, different retailers may use different data formats for representing the UPC code information. Therefore, a matching algorithm is used to examine the data in the UPC code field of the retailer product table 100, and reformat this information to the same format as used in the aggregator product table 200. In an embodiment, the method of FIG. 4a-c is used to conform the retailer UPC code field 110a data to the aggregator product table 200 format.

The method of FIG. 4a begins at step 402, where a UPC code is retrieved from the retailer product table 100 for the selected entry in the retailer product table 100. Then at step 404, the UPC code is stripped of any leading zeros as well as any non-numeric characters. At step 406, the number of digits in the stripped UPC code is checked. If the stripped UPC code has 13 digits in it, then control passes to step 408. At step 408, the last (i.e. right-most) digit in the UPC code is examined to see if that digit matches an expected check digit value for the UPC code. A check digit for a UPC code is a digit that is used to check whether the UPC code contains any errors in it.

For example, a UPC code check digit can be a modulo-10 check digit. To compute the check digit, add together the digits in the odd numbered positions, and then multiply this total by three. Then add the digits in the even numbered positions. Then add the two results together. Then find the single digit value that makes this total result a multiple of 10. That single digit value is the check digit.

Thus, for an example UPC code of 55562889233, the odd-numbered digits are 5+5+2+8+2+3=25. 25*3=75. The even numbered digits are 5+6+8+9+3=31. Adding the two results together is 75+31=106. The single digit that makes this value a multiple of 10 is 4 (106+4=110). So the check digit in this example would be 4. Thus, this UPC code, with the check digit, would be represented as 555628892334

At step 408, the stripped UPC code from step 406 is evaluated, for example using the above-described computation, to determine whether the last digit matches the expected check digit value for the stripped UPC code. If this is a match, then at step 410 the non-numeric characters are stripped from the original UPC code retrieved from the retailer product table for the selected entry. At step 412, the last digit (i.e. the check digit) is then stripped from the UPC code of step 410. At step 414, the UPC code is formatted to match any particular conventions used for storing UPC codes in the aggregator table 200. In an embodiment, a hyphen is added between the second and third digits and between the seventh and eighth digits of the UPC code of step 412. This conforms the format of the UPC code from the retailer data table 100 to the format used in the aggregator data table 200.

Once the UPC code is reformatted to conform to the format used in the aggregator data table 200, then at step 416, the aggregator data table 200 is searched for a matching UPC code. If a matching UPC code is found, then this code is returned as a match, and the corresponding product information from the retailer data table 100 and the aggregator table 200 are stored as a row in the merged product table 310. See FIG. 6a, which shows a single row added to the merged product table 310. The method then ends. As noted above, this method is invoked once for each row in the retailer product table 100.

If at step 408, the last digit does not match the expected check digit value for the stripped UPC code, then this UPC code is reported as an invalid code at step 418. No product information is stored in the merged product table 310 for this entry in the retailer product table 100 and the method ends.

If at step 406, the stripped UPC code is not 13 digits, then at step 420 the stripped UPC code is checked to see if it is 12 digits long. If so, then at step 422 the stripped UPC code is evaluated, for example using the above-described computation, to determine whether the last digit matches the expected check digit value for the stripped UPC code. If this is a match, then at step 424 control passes to the substeps shown in FIG. 4b.

If at step 422 the last digit does not match the expected check digit value for the stripped UPC code, then this UPC code is a code that does not use a check digit. At step 426, the leading zeros and non-numeric characters are stripped from the original UPC code retrieved from the retailer product table for the selected entry. At step 428, the UPC code is formatted to match any particular conventions used for storing UPC codes in the aggregator table 200. In an embodiment, a hyphen is added between the second and third digits and between the seventh and eighth digits of the UPC code of step 426. This conforms the format of the UPC code from the retailer data table 100 to the format used in the aggregator data table 200.

Once the UPC code is reformatted to conform to the format used in the aggregator data table 200, then at step 430, the aggregator data table 200 is searched for a matching UPC code. If a matching UPC code is found, then this code is returned as a match, and the corresponding product information from the retailer data table 100 and the aggregator table 200 are stored as a row in the merged product table 310. The method then ends. As noted above, this method is invoked once for each row in the retailer product table 100.

If at step 420 the stripped UPC code is not 12 digits, then the stripped UPC code must be less than 12 digits as identified at step 432. Then at step 434 the stripped UPC code is then evaluated, for example using the above-described computation, to determine whether the last digit matches the expected check digit value for the stripped UPC code. If this is a match, then at step 436 control passes to the substeps shown in FIG. 4c.

If at step 434 the last digit does not match the expected check digit value, then this UPC code is a code that does not use a check digit. At step 438, the original UPC code is stripped of all non-numeric characters. At step 440 enough leading zeros are added to the UPC code from step 428, to make that UPC code 12 digits long. At step 442, the UPC code is formatted to match any particular conventions used for storing UPC codes in the aggregator table 200. In an embodiment, a hyphen is added between the second and third digits and between the seventh and eighth digits of the UPC code of step 440. This conforms the format of the UPC code from the retailer data table 100 to the format used in the aggregator data table 200.

Once the UPC code is reformatted to conform to the format used in the aggregator data table 200, then at step 444, the aggregator data table 200 is searched for a matching UPC code. If a matching UPC code is found, then this code is returned as a match, and the corresponding product information from the retailer data table 100 and the aggregator table 200 are stored as a row in the merged product table 310. The method then ends. As noted above, this method is invoked once for each row in the retailer product table 100.

Turning to FIG. 4b, this sub-process is entered at step 424 (from FIG. 4a). At step 446, the UPC code of step 424 is transformed into two different UPC codes, because at this step it is unclear whether the UPC code has a check digit or not. The first candidate UPC code (UPC1) is generated in steps 448-452. The candidate UPC1 code does not have a check digit. The second candidate UPC code (UPC2) is generated in steps 454-468. The candidate UPC2 code does have a check digit.

At step 448, the original UPC code retrieved from the retailer product table 100 is stripped of leading zeros and non-numeric characters. At step 450, the UPC code is formatted to match any particular conventions used for storing UPC codes in the aggregator table 200. In an embodiment, a hyphen is added between the second and third digits and between the seventh and eighth digits of the UPC code of step 448. This conforms the format of the UPC code from the retailer data table 100 to the format used in the aggregator data table 200. Once the UPC code is reformatted to conform to the format used in the aggregator data table 200, then at step 452, the aggregator data table 200 is searched for a matching UPC code. If a matching UPC code is found, then this code is returned as a match.

Then at step 454 the original UPC code retrieved from the retailer product table 100 is stripped of leading zeros and non-numeric characters. At step 456 the last digit is stripped from the UPC code. At step 458 a leading zero is added to the UPC code. At step 460, the UPC code is formatted to match any particular conventions used for storing UPC codes in the aggregator table 200. In an embodiment, a hyphen is added between the second and third digits and between the seventh and eighth digits of the UPC code of step 448. This conforms the format of the UPC code from the retailer data table 100 to the format used in the aggregator data table 200. Once the UPC code is reformatted to conform to the format used in the aggregator data table 200, then at step 462, the aggregator data table 200 is searched for a matching UPC code. If a matching UPC code is found, then this code is returned as a match.

Control then passes to step 464, where a check is made to see whether either UPC1 or UPC2, or both, matched an entry in the aggregator product table 200. If neither UPC1 nor UPC2 matched an entry, then the UPC code is an invalid code and at step 468 no match is returned and no data is added to the merged table 310. Control then passes back to step 424 of FIG. 4a. If both UPC1 and UPC2 match entries, then the UPC code is an ambiguous code and the method is unable to identify a valid match. At step 468 no match is returned and no data is added to the merged table 310. Control then passes back to step 424 of FIG. 4a.

If, however, only one of UPC1 and UPC2 match an entry, then this entry is returned as a match, and the corresponding product information from the retailer data table 100 and the aggregator table 200 are stored as a row in the merged product table 310. Control then passes back to step 424 of FIG. 4a.

Turning to FIG. 4c, this sub-process is entered at step 436 (from FIG. 4a). At step 470, the UPC code of step 436 is transformed into two different UPC codes, because at this step it is unclear whether the UPC code has a check digit or not. The first candidate UPC code (UPC1) is generated in steps 472-478. The candidate UPC1 code does not have a check digit. The second candidate UPC code (UPC2) is generated in steps 480-488. The candidate UPC2 code does have a check digit.

At step 472, leading zeros are added to the original UPC code retrieved from the retailer product table 100, to make the UPC code 12 digits long. At step 474, the UPC code is stripped of non-numeric characters. At step 476, the UPC code is formatted to match any particular conventions used for storing UPC codes in the aggregator table 200. In an embodiment, a hyphen is added between the second and third digits and between the seventh and eighth digits of the UPC code of step 474. This conforms the format of the UPC code from the retailer data table 100 to the format used in the aggregator data table 200. Once the UPC code is reformatted to conform to the format used in the aggregator data table 200, then at step 478, the aggregator data table 200 is searched for a matching UPC code. If a matching UPC code is found, then this code is returned as a match.

Then at step 480 the original UPC code retrieved from the retailer product table 100 is stripped of non-numeric characters. At step 482 the last digit is stripped from the UPC code. At step 484 enough leading zeros are added to the UPC code to make that code 12 digits long. At step 486, the UPC code is formatted to match any particular conventions used for storing UPC codes in the aggregator table 200. In an embodiment, a hyphen is added between the second and third digits and between the seventh and eighth digits of the UPC code of step 484. This conforms the format of the UPC code from the retailer data table 100 to the format used in the aggregator data table 200. Once the UPC code is reformatted to conform to the format used in the aggregator data table 200, then at step 488, the aggregator data table 200 is searched for a matching UPC code. If a matching UPC code is found, then this code is returned as a match.

Control then passes to step 490, where a check is made to see whether either UPC1 or UPC2, or both, matched an entry in the aggregator product table 200. If neither UPC1 nor UPC2 matched an entry, then the UPC code is an invalid code and at step 494 no match is returned and no data is added to the merged table 310. Control then passes back to step 436 of FIG. 4a. If both UPC1 and UPC2 match entries, then the UPC code is an ambiguous code and the method is unable to identify a valid match. At step 494 no match is returned and no data is added to the merged table 310. Control then passes back to step 436 of FIG. 4a.

If, however, only one of UPC1 and UPC2 match an entry, then this entry is returned as a match, and the corresponding product information from the retailer data table 100 and the aggregator table 200 are stored as a row in the merged product table 310. Control then passes back to step 436 of FIG. 4a.

In an embodiment, once the merged product table 310 is fully populated with rows from the retailer product table 100 and the corresponding rows from the aggregator product table 200, the merged product table 310 is evaluated to identify how many rows exist in the merged product table 310 for each desired attribute value (or combination of values) in the aggregator product table 200. For example, if the aggregator product table 200 includes a particular category value (for example BEERS), or a sub-category value (for example FROZEN BURRITOS), it is desirable to determine whether the particular retailer whose data is in the retailer product table 100 sells products in the category or sub-category of interest. If a retailer does not sell such products, then it may not be desirable to predict a retailer hierarchy for the items in the indicated category or sub-category. In an embodiment, if there are fewer than a threshold value number of rows (e.g. 5 rows) in the merged data that have the indicated category, sub-category or other attribute value of interest, then all such rows are removed from the merged data, as this indicates that the retailer does not sell this particular category/sub-category/attribute value.

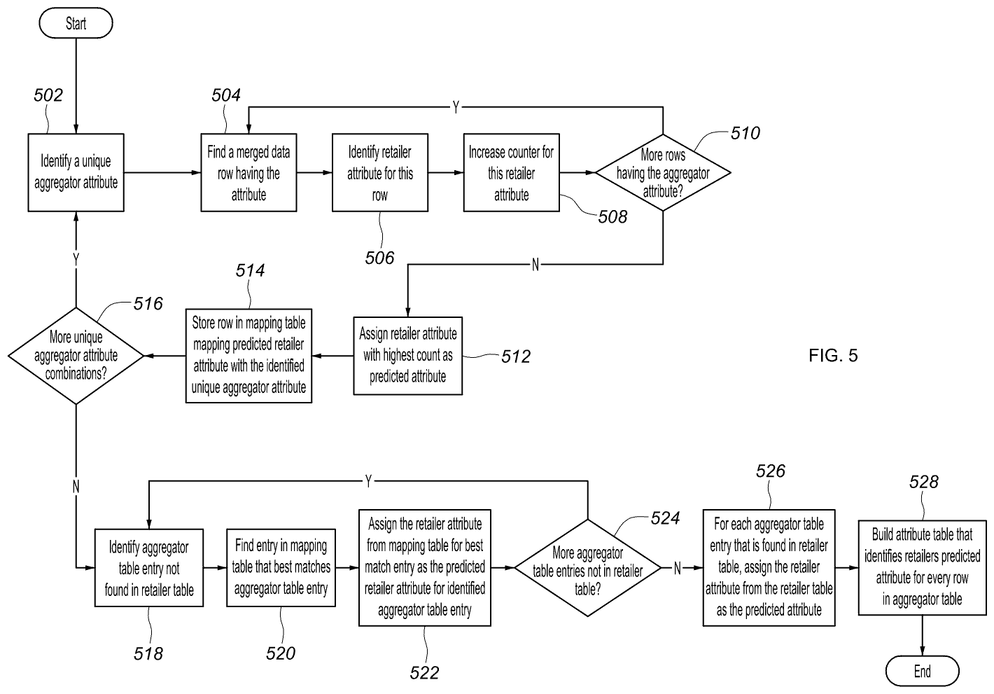

Once the merged product table 310 has been cleared of rows that reflect product attributes that the retailer does not sell, then the method of FIG. 5 is used to predict for each entry in the aggregator's hierarchy what the retailer's corresponding hierarchy would be if it were carried by the retailer.

Turning to FIG. 5, the method begins at step 502, where a unique attribute (or combination of attributes) is identified in the aggregator data table 200. In an embodiment, one or more columns from the aggregator data table 200 are designated as attribute columns. Each unique attribute value (or combination of values) from the designated attribute columns are selected in turn using the method of FIG. 5. For example, referring to the aggregator data table 200, the columns Department (202c), Category (202d) and Subcategory (202e) can be designated as attribute columns. Alternatively, other columns could be added to the designated attribute columns, such as Is Organic (202f) or other such columns. Preferably, the UPC and Description columns are not designated as attribute columns, to reduce the complexity of the analysis.

At step 502, one of the unique aggregator attributes is identified. Then at step 504, the merged data table 310 is searched to find a row that has the identified unique aggregator attribute. At step 506, the corresponding retailer attribute (or combination of attributes) is identified for the identified unique aggregator attribute. For example, if the unique aggregator attribute were the value pair “Category=BEERS; Subcategory=India Pale Ales”, a row in the merged data table 310 that has this aggregator value pair may be row 312a. This row contains a retailer attribute of “Category=Beer”. Once the corresponding retailer attribute is identified, then at step 508 a counter for that retailer attribute is increased by one, to count the fact that a row was found in the merged data table 310 that contained this retailer attribute. At step 510, the merged data table is checked to see if there are more rows that contain the unique aggregator attribute. If so then control passes back to step 504 to process the next row. Once all rows having the unique aggregator attribute are processed, then control passes to step 512. At step 512, the counters for each of the identified retailer attributes from steps 504-508 are examined, and the retailer attribute with the highest counter value is selected as the predicted retailer attribute for the identified unique aggregator attribute of step 504. For example, if the above process steps resulted in a count of three instances where the retailer attribute was “Category=Beer” and two instances where the retailer attribute was “Category=Novelty Drink”, for the identified unique aggregator attribute value pair “Category=BEER; Subcategory=India Pale Ales”, then the predicted retailer attribute would be “Category=Beer” for this aggregator attribute value pair.

At step 514, this relationship is written into a mapping table 910, to map the predicted retailer attribute to the identified unique aggregator attribute. Then at step 516 the aggregator data table 200 is checked for the next unique aggregator attribute. If such an attribute is identified, then control passes back to step 502 for this attribute to be processed. Once all the unique aggregator attributes are processed, then control passes to step 518.

At steps 518-524, the method uses the mapping table 910 created in the previous steps to identify predicted retailer attributes for products that are in the aggregator data table 200 but are not found in the retailer data table 100. These products represent products in the aggregator data table that are not sold by the particular retailer whose data is in table 100. For example, these could be products for a brand that the retailer does not carry, or those for a product size that the retailer does not carry. The retailer, however, is still interested in comparing the brands and sizes it does sell with other products in the same channel. For example, if a retailer sells one type of beer, it would still be interested in comparing its sales of that type of beer to sales of other types of beer by other retailers. Thus, the retailer needs to be able to understand information about these other products, in the context of the retailer's attributes and attribute combinations.

Therefore, at step 518, An entry in the aggregator table 200 that has no corresponding entry in the retailer data table 100 is identified. At step 520, the mapping table 910 is searched to find the entry in this table that best matches the aggregator table entry. Recall that the mapping table 910 is built by finding those products that exist in both the retailer table 100 and the aggregator table 200. Thus, it is possible, and sometimes likely, that a product existing only in the aggregator table 200 will not have a perfect match in this mapping table. For example, if the retailer sells a specific type of beer, then this type is the only one that will show up in the mapping table 910, so a perfect match with an aggregator table entry for a different type of beer will not be possible. Therefore, in an embodiment the best available match is found at step 520. Alternatively, a “good enough” match can be made, where the match exceeds a threshold value of similarity. This trades off some accuracy for speed of processing the data.

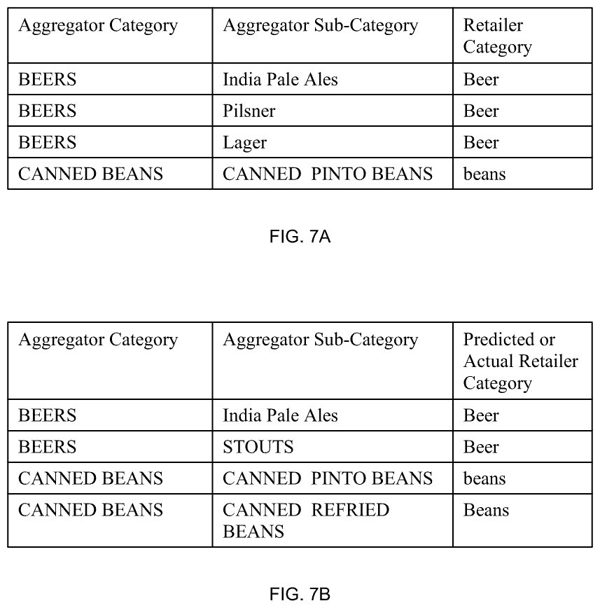

In one embodiment, to find the best available match, the mapping table 910 is searched to find the entry that contains the most attribute elements in common with the given aggregator table entry. Thus, for an aggregator table entry having the following values:
Department—ALCOHOLIC BEVERAGES
Category—BEERS
Sub-Category—India Pale Ales
Is Organic—True
   and a mapping table 910 having the entries shown in FIG. 7a, the entry in row 1 is selected. Row 1 matches two attributes, Category and Sub-Category. The entries in Rows 2 and 3, on the other hand, match only one of the attributes (Category). The entry in Row 4 matches none of the attributes.

At step 522, the retailer attribute from the mapping table entry that best matched the aggregator table entry is identified as the predicted retailer attribute that corresponds to the aggregator table entry. At step 524, a check is made for additional aggregator table entries that do not have a corresponding entry in the retailer table. If there are any more such entries, then control passes back to step 518 for the next entry to be processed. Once all the aggregator table entries without corresponding retailer table entries are processed, then control passes to step 526. At step 526, each aggregator table entry that does have a corresponding retailer table entry is identified, and the retailer attribute found in the retailer table is assigned as the predicted retailer attribute. That is, for those aggregator table entries that the retailer does sell, simply use the retailers known attribute as the identified attribute for those rows. Finally, at step 528 an attribute table 920 is built (with reference to FIG. 7b), which identifies the predicted retailer attribute for each row in the aggregator table.

For those products that the retailer sells, the attribute table 920 lists the retailer's attribute for that product. For those products that the retailer does not sell, the attribute table 920 lists the predicted retailer attribute for that product. Through the use of methods of embodiments of the invention as discussed above, a retailer is able to meaningfully compare information about its own products, with corresponding information about all other products found in the aggregator's database. Advantageously, this comparison is done in the context of the retailer's own attributes, regardless of any differences between the retailer's attribute hierarchy and the aggregator's hierarchy. Furthermore, since this machine learning method can be applied to any retailer's data, the methods of embodiments of the invention are able to seamlessly present aggregated sales and other information to each of a wide range of retailers, in the retailer's own attribute hierarchy. This allows the retailers to meaningfully evaluate the aggregated data and compare it with the retailers own data, without requiring the retailer to learn an entirely new or different taxonomy for describing these products. Additionally, the aggregator can seamlessly intake a new retailer and integrate their data into the aggregator's database.

Accordingly, persons of ordinary skill in the art will understand that, although particular embodiments have been illustrated and described, the principles described herein can be applied to different types of machine learning systems. Certain embodiments have been described for the purpose of simplifying the description, and it will be understood to persons skilled in the art that this is illustrative only. Accordingly, while this specification highlights particular implementation details, these should not be construed as limitations on the scope of any invention or of what may be claimed, but rather as descriptions of features that may be specific to particular embodiments of particular inventions.

What is claimed is:

1. A method of training a machine learning system to predict retailer information attributes in retailer information data, comprising:
a. Providing an aggregation of product information of a plurality of retailers, the aggregation comprising an aggregator data table including a first keyfield having a first format and a plurality of aggregator attribute fields;
b. Providing a collection of product information of a first retailer, the collection comprising a retailer data table including a second keyfield having a second format and a plurality of retailer attribute fields.
c. Processing the second keyfield data to convert the second format to the first format.
d. Creating a merged data table by merging the aggregator data table with the retailer data table, such that the merged data table contains a plurality of rows of data, each row comprising a combination of information in a row of the aggregator data table and a row of the retailer data table where a first keyfield value from the row of the aggregator data table matches a second keyfield value form the row of the retailer data table.
e. Selecting a first attribute field of the plurality of aggregator attribute fields from the merged data table;
f. Selecting a first attribute value from a plurality of values expressed in the plurality of aggregator attribute fields;
g. Selecting a second attribute field of the plurality of retailer attribute fields from the merged data table;
h. Finding a most commonly appearing retailer attribute value from the selected second attribute field and identifying said attribute value as a predicted attribute value; and
i. Creating a row in a mapping table that maps the predicted attribute value with the selected first attribute value.

2. The method of claim 1, further comprising building an attribute table that predicts a retailer attribute value for at least one row of the aggregator data table, wherein the row of the aggregator data table does not have a matching row in the retailer data table.

3. A method of training a machine learning system to identify a plurality of attributes of a retailer hierarchy by building an attribute hierarchy for the plurality of retailer attributes, said attribute hierarchy describing attributes of data stored in an aggregator data table, comprising:
a. Providing a mapping table that maps a plurality of predicted attribute values for a plurality of retailer attributes, to a plurality of attribute values for a plurality of aggregator attributes.
b. Providing an aggregator data table comprising a plurality of rows of aggregator product information.
c. Providing a retailer data table comprising a plurality of rows of retailer product information.
d. Identifying a first aggregator table entry that does not correspond to any entries in the retailer data table.
e. Determining an entry in the mapping table that best matches said first aggregator table entry.
f. Assigning a first retailer attribute from the entry in the mapping table as the predicted retailer attribute for said first aggregator table entry.
g. Identifying a second aggregator table entry that corresponds to an entry in the retailer data table.
h. Assigning a second retailer attribute from the entry in the retailer data table as the predicted retailer attribute for said second aggregator table entry.
i. Creating a first entry in an attribute table, the first entry correlating the first retailer attribute and the first aggregator table entry; and
j. Creating a second entry in the attribute table, the second entry correlating the second retailer attribute and the second aggregator table entry.
